(19) United States
(12) Patent Application Publication
(10) Pub. No.: US 2025/0364868 A1
(43) Pub. Date: Nov. 27, 2025

(54) MODULAR FIVE-DEGREE-OF-FREEDOM MAGNETIC LEVITATION COMPRESSOR ROTOR SYSTEM

(71) Applicant: Shenyang University of Technology, Shenyang (CN)

(72) Inventors: Chuan Zhao, Shenyang (CN); Feng Sun, Shenyang (CN); Xinqi Zhao, Shenyang (CN); Fangchao Xu, Shenyang (CN); Junjie Jin, Shenyang (CN); Dongning Liu, Shenyang (CN); Haining Zhao, Shenyang (CN); Ran Zhou, Shenyang (CN); Hang Shen, Shenyang (CN); Qinwei Zhang, Shenyang (CN)

(73) Assignee: Shenyang University of Technology, Shenyang (CN)

(21) Appl. No.: 19/290,336

(22) Filed: Aug. 4, 2025

(30) Foreign Application Priority Data
Mar. 21, 2025 (CN) 202510341759.4

(51) Int. Cl. H02K 7/09; F16C 32/04; F25B 31/02; H02K 21/14

(52) U.S. Cl. CPC H02K 7/09; F16C 32/048; F25B 31/02; H02K 21/14; F16C 2360/44; F16C 2380/26; H02K 2201/18; H02K 2213/06; H02K 2213/12

(57) ABSTRACT

The present disclosure discloses a modular five-degree-of-freedom magnetic levitation compressor rotor system and a control method, comprising a magnetically levitated rotor spindle and a drive motor arranged at a middle part of the magnetically levitated rotor spindle, a centrifugal impeller and a cooling impeller are respectively mounted at both ends of the magnetically levitated rotor spindle, an axial magnetic bearing assembly and a radial magnetic bearing assembly are sequentially arranged on the magnetically levitated rotor spindle between the drive motor and the centrifugal impeller, as well as on the magnetically levitated rotor spindle between the drive motor and the cooling impeller, the axial magnetic bearing assembly is a thrustless plate structure with a direct magnetic field coupling; the radial magnetic bearing assembly adopts a modular structure with segmented magnetic poles.

### TECHNICAL FIELD

The present disclosure relates to the field of compressor rotor technology, particularly to a modular five-degree-of-freedom magnetic levitation compressor rotor system.

### BACKGROUND

Compressors have a wide range of applications in fields such as air conditioning, refrigeration equipment, and hydrogen production equipment; as well as in industries such as textiles, metallurgy, chemicals, fermentation, glass production, pharmaceuticals, and papermaking. Magnetic levitation compressors achieve non-contact operation by using magnetic levitation technology and adopting magnetic levitation bearings to levitate the compressor rotor in the magnetic field. This design reduces energy loss and noise caused by mechanical bearing friction in conventional compressors, thereby improving the efficiency and reliability of the system.

Existing magnetic levitation compressors typically achieve the stable levitation of the rotor by using one axial thrust magnetic bearing and two radial magnetic levitation bearings. The axial thrust magnetic bearing has two stators and a thrust plate. During assembly with the above structure, firstly, one stator is mounted, secondly, the thrust plate is mounted on the shaft using a thermal assembly process, and finally, the other stator is mounted. It can be seen that assembly is relatively difficult, and it is inconvenient to disassemble when a fault occurs. Additionally, the maximum speed of the rotor is limited by the thrust plate, leading to a significant loss during operation.

As reliable as radial magnetic levitation bearings have proven to be, there are still several instances of bearing system failure that have resulted in rotor drop. Two types of redundant designs are typically used to improve the reliability of radial magnetic bearings: one is an independent redundant structure design, that is, an independent backup bearing is designed, and if the primary bearing fails, the backup bearing will start up to continue providing support. This design mode increases the complexity of the structure, leading to increases in assembly difficulty, maintenance difficulty, and manufacturing costs. Another type is the analytical redundant structure, that is, based on the different failure characteristics of the magnetic poles, the support is reconstructed by selecting and configuring the useful parts of the residual structure. This design requires each magnetic pole to be independent, and each magnetic pole must be equipped with a power amplifier, which increases the power consumption and manufacturing cost of the magnetic bearing system.

### SUMMARY

An objective of the present disclosure is to provide a modular five-degree-of-freedom magnetic levitation compressor rotor system and a control method to solve the above technical problems.

In order to achieve the above objective, the present disclosure provides a modular five-degree-of-freedom magnetic levitation compressor rotor system, including a magnetically levitated rotor spindle and a drive motor arranged at a middle part of the magnetically levitated rotor spindle, a centrifugal impeller and a cooling impeller are respectively mounted at both ends of the magnetically levitated rotor spindle, an axial magnetic bearing assembly and a radial magnetic bearing assembly are sequentially arranged on the magnetically levitated rotor spindle between the drive motor and the centrifugal impeller, as well as on the magnetically levitated rotor spindle between the drive motor and the cooling impeller, the axial magnetic bearing assembly is a thrustless plate structure with a direct magnetic field coupling; the radial magnetic bearing assembly adopts a modular structure with segmented magnetic poles.

Preferably, the axial magnetic bearing assembly includes an axial rotor assembly sleeved outside the magnetically levitated rotor spindle and an axial stator assembly sleeved outside the axial rotor assembly, with an air gap formed between the axial rotor assembly and the axial stator assembly;
the axial stator assembly includes an axial stator core and an axial coil winding, wherein the axial coil winding is wound between two axial stator magnetic poles on the axial stator core;
the axial rotor assembly includes an axial rotor core and an axial rotor magnetic pole integrally formed with a surface of the axial rotor core;
the axial stator poles partially overlap with the axial rotor magnetic poles in an axial direction, with an overlapping width being ⅕ of a width of either the axial rotor magnetic poles or the axial stator magnetic poles, and the overlapping directions of the two axial magnetic bearing assemblies positioned on both sides of the drive motor are opposite.

Preferably, the radial magnetic bearing assembly includes cages at two ends, and a modular radial magnetic pole assembly, a radial coil winding and a radial rotor iron core lamination arranged from outside to inside in a mounting cavity enclosed by the cages at the two ends, wherein the modular radial magnetic pole assembly includes multiple E-shaped magnetic poles uniformly arranged in a circumferential array on an inner wall of one of the cages, middle pole columns are arranged at a middle position of an inner arc side of each E-shaped magnetic pole, side pole columns are axially symmetrically arranged on both sides of the middle pole column, a width of the middle pole column is twice a width of the side pole column, and radial coil windings are wound on both the middle pole column and side pole column;
the radial coil windings form South-North-South (SNS) magnetic poles when energized, thereby forming an electromagnetic circuit from the middle pole column through the radial rotor iron core lamination and side pole column, and back to the middle pole column.

Preferably, two magnetic pole grooves are provided on an outer arc side of one E-shaped magnetic pole, with the two magnetic pole grooves respectively positioned between the two side pole columns and the middle pole column, and a permanent magnet is arranged in the magnetic pole groove, and a N pole of the permanent magnet is toward the middle pole column to form a permanent magnet magnetic circuit consisting of the N pole of the permanent magnet, the middle pole column, the radial rotor core lamination, the side pole column, and an S pole of the permanent magnet.

Preferably, the radial coil windings on the side pole column of the same E-shaped magnetic pole are connected in series and then connected together with the radial coil windings wound on the middle pole column to a 2-in-4-out terminal block, the 2-in-4-out terminal block is connected to a power amplifier, enabling the three radial coil windings on the same E-shaped magnetic pole to share one power amplifier.

Preferably, both the side pole column and the middle pole column are wound with fault detection coils, and the fault detection coils are electrically connected to an operational amplifier;
to achieve a magnetic field generated under the action of electromagnetic induction when the current passes through the radial coil winding under normal conditions, at this point, when the radial coil winding changes, the generated magnetic flux changes, and according to Faraday's Law of Electromagnetic Induction and Oersted's Law, the magnetic flux passing through the fault detection coil changes accordingly, an electromotive force is induced, thereby forming a voltage difference at both ends of the radial coil winding, a voltage difference signal is processed by the operational amplifier and then output to the operational amplifier, and the voltage difference signal amplified by the operational amplifier is used to determine that the radial coil winding is normal;
when a fault occurs in the radial coil winding, a change in the current flowing to the radial coil winding will not cause a change in the voltage difference signal amplified by the operational amplifier, thereby determining that the fault has occurred in the radial coil winding.

Preferably, an inductive displacement sensor is further arranged on the magnetically levitated rotor spindle between the radial magnetic bearing assembly and the centrifugal impeller or the cooling impeller, the radial displacement sensor is electrically connected to the radial coil winding of the radial magnetic bearing assembly through a controller, so as to detect a radial displacement signal of the magnetically levitated rotor spindle and control the current supplied to the radial coil winding based on the inductive displacement sensor, thereby ensuring balance and stability of the magnetically levitated rotor spindle;
a protective bearing is arranged between the inductive displacement sensor and the centrifugal impeller or the cooling impeller;
both the centrifugal impeller and the cooling impeller are provided with splitter blades, and a diameter and a height of the centrifugal impeller are respectively greater than a diameter and a height of the cooling impeller.

Preferably, the inductive displacement sensor includes a sensor measuring ring sleeved on the magnetically levitated rotor spindle and a sensor stator core sleeved outside the sensor measuring ring, with the air gap formed between the sensor stator core and the sensor measuring ring, an even number of sensor magnetic poles are uniformly arranged on an inner side of the sensor stator core, each sensor magnetic pole is wound with the sensor coil winding, the opposing sensor coil windings are connected in series with opposite winding directions, wherein one of two adjacent sensor coil windings is energized while the other is de-energized.

Preferably, the axial stator core, axial rotor core, radial rotor core lamination, E-shaped magnetic pole and sensor stator core are all made of silicon steel; the permanent magnet is made of rare-earth permanent magnet material; and the sensor measuring ring is made of permalloy.

Preferably, a control method for the modular five-degree-of-freedom magnetic levitation compressor rotor system, including an axial displacement control and a radial displacement control;
the steps of the axial displacement control are as follows: supplying currents with opposite directions and equal magnitudes to the axial coil windings of the two axial magnetic bearing assemblies position on both sides of the drive motor, so that a resultant axial force on the magnetically levitated rotor spindle is zero and the levitation balance is maintained. When the magnetically levitated rotor spindle drives the axial rotor assembly to undergo the axial displacement, causing a degree of overlap between the axial stator magnetic poles and the axial rotor magnetic poles to change. At this point, reducing the current supplied to the axial coil winding on the side where the degree of overlap increases, and increasing the current supplied to the axial coil winding on the side where the degree of overlap decreases, thereby generating a reverse axial electromagnetic force until the magnetically levitated rotor spindle restores balance.

The radial displacement control includes a speed-based variable bias current control strategy and a redundant control strategy under fault conditions. Wherein the speed-based variable bias current control strategy is as follows: when the speed of the magnetically levitated rotor spindle is zero or lower than a preset first threshold, the magnetically levitated rotor spindle is levitated by utilizing the permanent magnetic force provided by the permanent magnet. When the magnetically levitated rotor spindle rotates at a second threshold, a first bias current is supplied to the radial coil winding to generate the electromagnetic magnetic circuit, and the electromagnetic magnetic circuit is superimposed with the permanent magnetic circuit generated by the permanent magnet to enhance radial stiffness, thereby levitating the magnetically levitated rotor spindle. When the magnetically levitated rotor spindle rotates at a third threshold, a second bias current is supplied to the radial coil winding to increase the radial stiffness, thereby levitating the magnetically levitated rotor spindle. Wherein the third threshold, the second threshold, and the first threshold decrease sequentially, and the second bias current is greater than the first bias current;

The redundant control strategy is as follows: when a fault occurs in the radial coil winding on the side pole column, the current of the radial coil winding on the middle pole column is increased to compensate the electromagnetic magnetic flux, thereby maintaining the radial displacement stiffness in the direction of the E-shaped magnetic pole unchanged. When a fault occurs in the radial coil winding on the middle pole column, the current of the radial coil windings on the two side pole columns are increased to compensate the electromagnetic magnetic flux, thereby maintaining the radial displacement stiffness in the direction of the E-shaped magnetic pole unchanged.

Therefore, the present disclosure adopts the above-mentioned modular five-degree-of-freedom magnetic levitation compressor rotor system and the control method, and has the beneficial effects as follows:
1, the axial magnetic bearing assembly with thrustless plate simplifies the assembly process of the axial magnetic bearing, reduces the loss during the operation of the equipment, and is conducive to the improvement of the maximum speed of the rotor. And the axial magnetic bearing assembly also increases the radial stiffness of the rotor system and improves the stability of the system. Specifically, the reliability of the radial magnetic bearing is improved and the energy loss and manufacturing cost of the radial magnetic bearing assembly are reduced;
2, the radial magnetic bearing assembly adopts modular design, when the fault occurs in the magnetic bearing system, it can be quickly disassembled to facilitate rapid and accurate positioning of the problem and repair;
3, a magnetic pole in the radial magnetic bearing assembly is introduced into the permanent magnet, which reduces the current requirement in the electromagnetic coil, only four power amplifiers are required to achieve the analytical redundancy design, so that the problem can be rapidly and accurately positioned and repaired.

Further detailed descriptions of the technical scheme of the present disclosure can be found in the accompanying drawings and embodiments.

### BRIEF DESCRIPTION OF THE DRAWINGS

FIG. 1 is the side view of a modular five-degree-of-freedom magnetic levitation compressor rotor system according to the present disclosure;

FIG. 2 is a cross-sectional view of a modular five-degree-of-freedom magnetic levitation compressor rotor system according to the present disclosure;

FIG. 3 is a structural schematic diagram of an axial magnetic bearing assembly of a modular five-degree-of-freedom magnetic levitation compressor rotor system according to the present disclosure;

FIG. 4 is a Maxwell simulation magnetic induction line distribution diagram of an axial magnetic bearing assembly of a modular five-degree-of-freedom magnetic levitation compressor rotor system according to the present disclosure;

FIG. 5 is an explosion diagram of a radial magnetic bearing assembly of a modular five-degree-of-freedom magnetic levitation compressor rotor system according to the present disclosure;

FIG. 6 is a magnetic circuit diagram of a radial magnetic bearing assembly of a modular five-degree-of-freedom magnetic levitation compressor rotor system according to the present disclosure;

FIG. 7 is a Maxwell simulation magnetic induction line distribution diagram of a radial magnetic bearing assembly of a modular five-degree-of-freedom magnetic levitation compressor rotor system according to the present disclosure;

FIG. 8 is a schematic diagram of a radial coil winding connection of a modular five-degree-of-freedom magnetic levitation compressor rotor system according to the present disclosure;

FIG. 9 is a schematic diagram of a circuit connection of a fault detection coil and an operational amplifier of a modular five-degree-of-freedom magnetic levitation compressor rotor system according to the present disclosure;

FIG. 10 is a structural schematic diagram of an inductive displacement sensor of a modular five-degree-of-freedom magnetic levitation compressor rotor system according to the present disclosure;

### REFERENCE NUMERALS IN FIGS

1, a magnetically levitated rotor spindle; 11, a shaft section; 2, a drive motor; 21, a motor stator; 22, a motor rotor core; 3, an axial magnetic bearing assembly; 31, an axial stator core; 32, an axial coil winding; 33, an axial rotor core; 34, a stator magnetic pole; 35, a rotor magnetic pole; 4, a radial magnetic bearing assembly; 41, a cage; 42, an E-shaped magnetic pole; 43, a permanent magnet; 44, a radial coil winding; 45, a radial rotor iron core lamination; 46, a 2-in-4-out terminal block; 47, a power amplifier; 48, a fault detection coil; 49, an operational amplifier; 410, a permanent magnet magnetic circuit; 411, an electromagnetic magnetic circuit; 412, a mounting groove; 413, a mounting hole; 414, a middle pole column; 415, a side pole column; 416, a magnetic pole groove; 5, an inductive displacement sensor; 51, a sensor stator core; 502, a sensor coil winding; 53, a sensor measuring ring; 54, a sensor magnetic pole; 6, a protective bearing; 7, a cooling impeller; 8, a centrifugal impeller; 9, a sleeve; 10, an air gap.

### DETAILED DESCRIPTION OF THE EMBODIMENTS

In order to make the objectives, the technical solutions, and the advantages of the present disclosure clearer, the following clearly and completely describes the technical solutions in embodiments of the present disclosure with reference to the embodiments of the present disclosure. It should be understood that the specific embodiments described herein are merely illustrative of the present disclosure and are not intended to limit the embodiments of the present disclosure. All other embodiments obtained by those of ordinary skill in the art based on the embodiments of the present disclosure without involving any creative effort shall fall within the scope of protection of the present disclosure. Examples of the embodiments are shown in the drawings, wherein like or similar reference numerals refer to the same or similar elements or elements having the same or similar function throughout.

It should be noted that the terms “comprises” and “having”, and any variations thereof, are intended to cover a non-exclusive inclusion, such that a process, method, system, article, or server that comprises a list of steps or elements is not necessarily limited to those steps or elements expressly listed, but may include other steps or elements not expressly listed or inherent to such process, method, article, or device.

The following is a detailed description of the embodiments of the present disclosure with reference to the accompanying drawings.

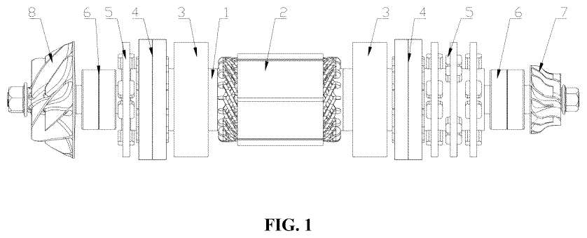

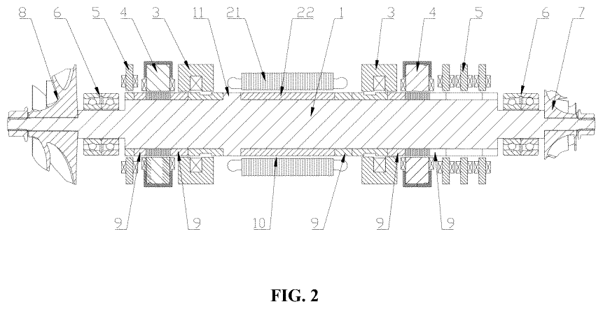

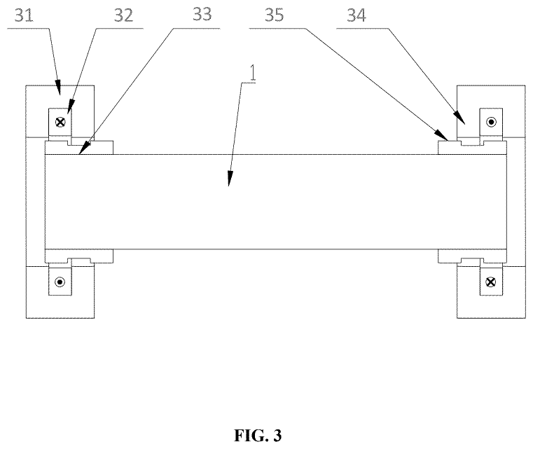

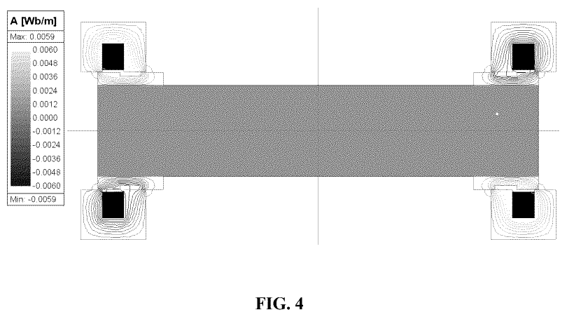

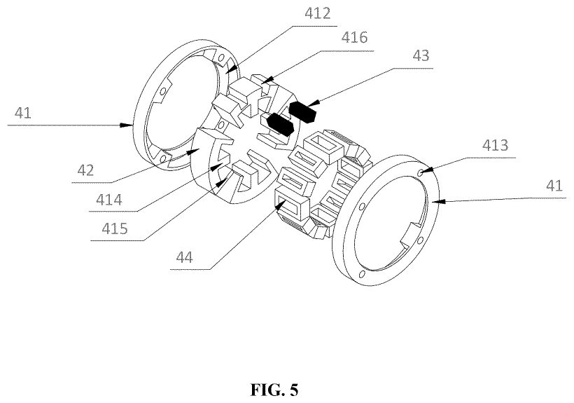

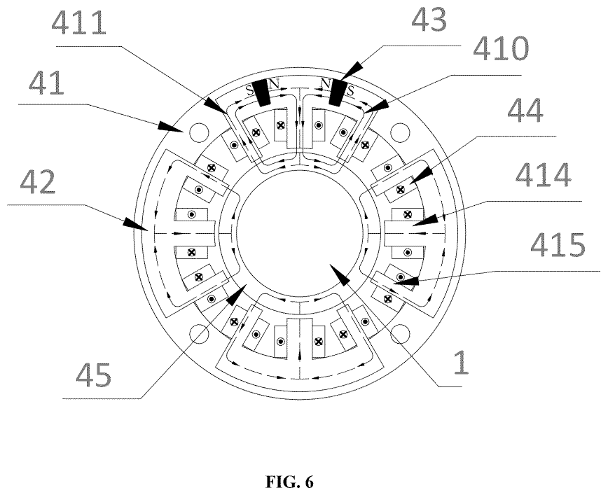

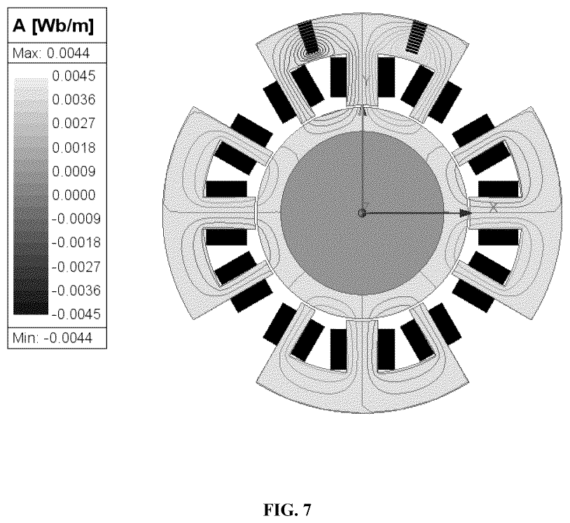

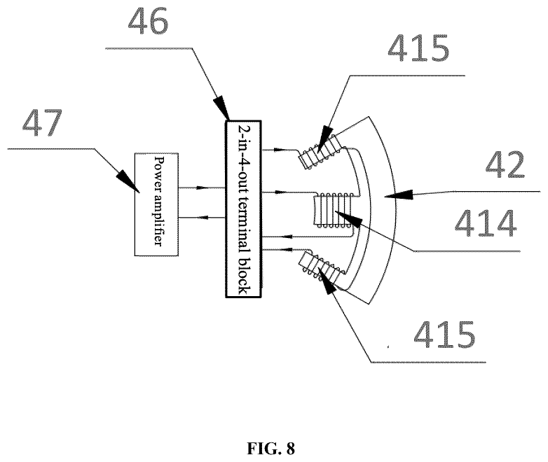

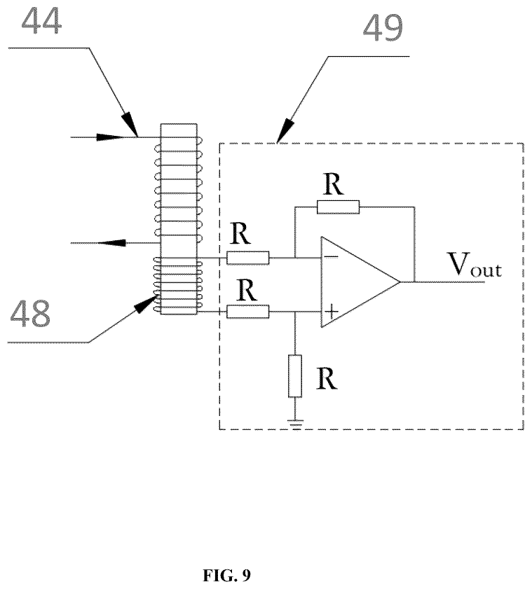

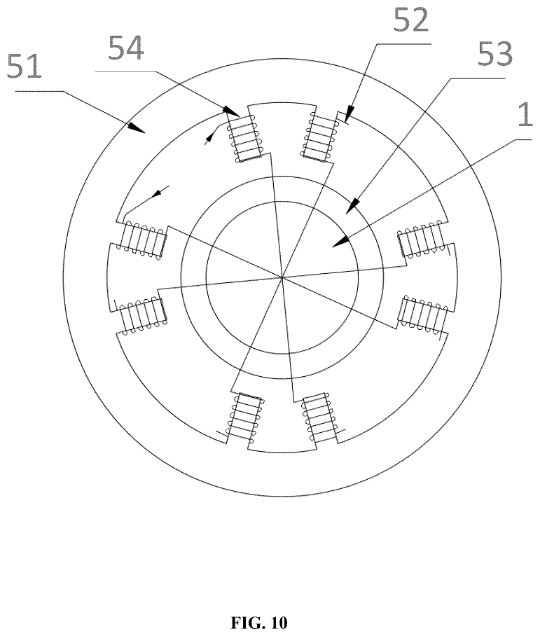

As shown in FIGS. 1-10, a modular five-degree-of-freedom magnetic levitation compressor rotor system, including the magnetically levitated rotor spindle 1 and the drive motor 2 arranged at the middle part of the magnetically levitated rotor spindle 1, in this embodiment, the motor rotor core 22 of the drive motor 2 is fixed in the middle part of the magnetically levitated rotor spindle 1 through the shaft section 11, and the motor stator 21 is sleeved outside the motor rotor core 22, the centrifugal impeller 8 and the cooling impeller 7 are respectively mounted at both ends of the magnetically levitated rotor spindle 1, the axial magnetic bearing assembly 3 and the radial magnetic bearing assembly 4 are sequentially arranged on the magnetically levitated rotor spindle 1 between the drive motor 2 and the centrifugal impeller 8, as well as on the magnetically levitated rotor spindle 1 between the drive motor 2 and the cooling impeller 7, the axial magnetic bearing assembly 3 is the thrustless plate structure with the direct magnetic field coupling; the radial magnetic bearing assembly 4 adopts the modular structure with segmented magnetic poles, the remaining two adjacent components on the magnetically levitated rotor spindle 1 are positioned by the sleeve 9.

Specifically, the axial magnetic bearing assembly 3 includes the axial rotor assembly sleeved outside the magnetically levitated rotor spindle 1 and the axial stator assembly sleeved outside the axial rotor assembly, with the air gap 10 formed between the axial rotor assembly and the axial stator assembly; the axial stator assembly includes the axial stator core 31 and the axial coil winding 32, wherein the axial coil winding 32 is wound between two axial stator magnetic poles 34 on the axial stator core 31; the axial rotor assembly includes the axial rotor core 33 and the axial rotor magnetic pole 35 integrally formed with the axial rotor core 33; the axial stator poles 34 partially overlap with the axial rotor magnetic poles 35 in the axial direction, with the overlapping width being ⅕ of the width of either the axial rotor magnetic poles 35 or the axial stator magnetic poles 34, and the overlapping directions of the two axial magnetic bearing assemblies 3 positioned on both sides of the drive motor 2 are opposite.

The radial magnetic bearing assembly 4 includes cages 41 at two ends, and the modular radial magnetic pole assembly, the radial coil winding 44 and the radial rotor iron core lamination 45 arranged from outside to inside in the mounting cavity enclosed by the cages 41 at the two ends, wherein the modular radial magnetic pole assembly includes multiple E-shaped magnetic poles 42 uniformly arranged in the circumferential array on the inner wall of one of the cages 41, the middle pole columns 414 are arranged at the middle position of the inner arc side of each E-shaped magnetic pole 42, the side pole columns 415 are axially symmetrically arranged on both sides of the middle pole column 414, the width of the middle pole column 414 is twice the width of the side pole column 415, the number of turns of the radial coil winding wound on the middle pole column 414 is twice the number of turns of the radial coil winding wound on the side pole column 415, and radial coil windings 44 are wound on both the middle pole column 414 and side pole column 415; the radial coil windings 44 form SNS magnetic poles when energized, thereby forming the electromagnetic circuit from the middle pole column 414 through the radial rotor iron core lamination 45 and side pole column 415, and back to the middle pole column 414.

In this embodiment, four E-shaped magnetic poles 42 are arranged, and the E-shaped magnetic pole 42 is engaged with the inner wall of one of the cages 41 by the mounting groove 412, and the end face of the other cage 41 is provided with a mounting hole 413 to maintain the stable connection of the two cages 41.

Two magnetic pole grooves 416 are provided on the outer arc side of one E-shaped magnetic pole 42, with the two magnetic pole grooves 416 respectively positioned between the two side pole columns 415 and the middle pole column 414, and the permanent magnet 43 is arranged in the magnetic pole groove 416, and the N pole of the permanent magnet 43 is toward the middle pole column 414 to form the permanent magnet magnetic circuit 410 consisting of the N pole of the permanent magnet 43, the middle pole column 414, the radial rotor core lamination 45, the side pole column 415, and the S pole of the permanent magnet 43.

The radial coil windings 44 on the side pole column 415 of the same E-shaped magnetic pole 42 are connected in series and then connected together with the radial coil windings 44 wound on the middle pole column 414 to the 2-in-4-out terminal block 46, the 2-in-4-out terminal block 46 is connected to the power amplifier 47, enabling the three radial coil windings 44 on the same E-shaped magnetic pole 42 to share one power amplifier 47.

Both the side pole column 415 and the middle pole column 414 are wound with fault detection coils 48, and the fault detection coils 48 are electrically connected to the operational amplifier 49; to achieve the magnetic field generated under the action of electromagnetic induction when the current passes through the radial coil winding 44 under normal conditions, at this point, when the radial coil winding changes, the generated magnetic flux changes, and according to Faraday's Law of Electromagnetic Induction and Oersted's Law, the magnetic flux passing through the fault detection coil 48 changes accordingly, the electromotive force is induced, thereby forming the voltage difference at both ends of the radial coil winding 44, the voltage difference signal is processed by the operational amplifier 49 and then output to the operational amplifier 49, and the voltage difference signal amplified by the operational amplifier 49 is used to determine that the radial coil winding 44 is normal; when the fault occurs in the radial coil winding 44, the change in the current flowing to the radial coil winding 44 will not cause the change in the voltage difference signal amplified by the operational amplifier 49, thereby determining that the fault has occurred in the radial coil winding 44.

The inductive displacement sensor 5 is further arranged on the magnetically levitated rotor spindle 1 between the radial magnetic bearing assembly 4 and the centrifugal impeller 8 or the cooling impeller 7, the radial displacement sensor is electrically connected to the radial coil winding 44 of the radial magnetic bearing assembly 4 through the controller, so as to detect the radial displacement signal of the magnetically levitated rotor spindle 1 and control the current supplied to the radial coil winding 44 based on the inductive displacement sensor 5, thereby ensuring balance and stability of the magnetically levitated rotor spindle 1; the protective bearing 6 is arranged between the inductive displacement sensor 5 and the centrifugal impeller 8 or the cooling impeller 7; both the centrifugal impeller 8 and the cooling impeller 7 are provided with splitter blades, and the diameter and the height of the centrifugal impeller 8 are respectively greater than the diameter and the height of the cooling impeller 7.

The inductive displacement sensor 5 includes the sensor measuring ring 53 sleeved on the magnetically levitated rotor spindle 1 and the sensor stator core 51 sleeved outside the sensor measuring ring 53, with the air gap 10 formed between the sensor stator core 51 and the sensor measuring ring 53, the even number of sensor magnetic poles 54 are uniformly arranged on the inner side of the sensor stator core 51, each sensor magnetic pole 54 is wound with the sensor coil winding 502, the opposing sensor coil windings 502 are connected in series with opposite winding directions, wherein one of two adjacent sensor coil windings 502 is energized while the other is de-energized.

The axial stator core 31, the axial rotor core 33, the radial rotor core lamination 45, the E-shaped magnetic pole 42, and the sensor stator core 51 are all made of silicon steel; the permanent magnet 43 is made of rare-earth permanent magnet material; and the sensor measuring ring 53 is made of permalloy.

The control method for the modular five-degree-of-freedom magnetic levitation compressor rotor system, including the axial displacement control and the radial displacement control;
the steps of the axial displacement control are as follows: currents with opposite directions and equal magnitudes are supplied to the axial coil windings 32 of the two axial magnetic bearing assemblies 3 position on both sides of the drive motor 2, so that the resultant axial force on the magnetically levitated rotor spindle 1 is zero and the levitation balance is maintained; when the magnetically levitated rotor spindle 1 drives the axial rotor assembly to undergo the axial displacement, causing the degree of overlap between the axial stator magnetic poles 34 and the axial rotor magnetic poles 35 to change, the current supplied to the axial coil winding 32 on the side where the degree of overlap increases is reduced, and the current supplied to the axial coil winding 32 on the side where the degree of overlap decreases is increased, thereby generating the reverse axial electromagnetic force until the magnetically levitated rotor spindle 1 restores balance;
the radial displacement control includes the speed-based variable bias current control strategy and the redundant control strategy under fault conditions, wherein the speed-based variable bias current control strategy is as follows: when the speed of the magnetically levitated rotor spindle 1 is zero or lower than the preset first threshold, the magnetically levitated rotor spindle 1 is levitated by utilizing the permanent magnetic force provided by the permanent magnet 43; when the magnetically levitated rotor spindle 1 rotates at the second threshold, the first bias current is supplied to the radial coil winding 44 to generate the electromagnetic magnetic circuit 411, and the electromagnetic magnetic circuit 411 is superimposed with the permanent magnetic circuit 410 generated by the permanent magnet to enhance radial stiffness, thereby levitating the magnetically levitated rotor spindle 1; when the magnetically levitated rotor spindle 1 rotates at the third threshold, the second bias current is supplied to the radial coil winding 44 to increase the radial stiffness, thereby levitating the magnetically levitated rotor spindle 1; wherein the third threshold, the second threshold, and the first threshold decrease sequentially, and the second bias current is greater than the first bias current;

It should be noted that the values of the first threshold, the second threshold, the third threshold, the first bias current and the second bias current set above need to be determined according to the size of the equipment. In this embodiment, the first threshold is the maximum speed of ⅓ rotor, the second threshold is the maximum speed of ⅔ rotor, and the third threshold is the maximum speed of rotor; the first bias current is ¼ of the maximum coil current, and the second bias current is ½ of the maximum coil current.

Furthermore, in this embodiment, when the faults occur in the middle pole column 414 and the side pole column 415 simultaneously, one end of the cage 41 can be opened, and the failed E-shaped magnetic pole 42 can be removed and replaced, since the entire radial magnetic bearing assembly 4 adopts a modular design, so that the entire radial magnetic bearing assembly 4 does not have to be completely disassembled during the replacement process, enabling rapid disassembly and assembly, which improves maintenance efficiency, thereby enhancing the reliability of the radial magnetic bearing assembly 4.

The redundant control strategy is as follows: when the fault occurs in the radial coil winding 44 on the side pole column 415, the current of the radial coil winding 44 on the middle pole column 414 is increased to compensate the electromagnetic magnetic flux (in the experimental environment, it is sufficient to increase the current in the radial coil winding 44 on the middle pole column 414 to twice the original value; in the actual environment, the current is adjusted based on the rotor vibration amplitude detected by the displacement sensor, that is, the current is increased until the difference between the rotor vibration and the vibration amplitude before the coil failure is less than the set value), thereby maintaining the radial displacement stiffness in the direction of the E-shaped magnetic pole 42 unchanged; when the fault occurs in the radial coil winding 44 on the middle pole column 414, the current of the radial coil windings 44 on the two side pole columns 415 are increased to compensate the electromagnetic magnetic flux, thereby maintaining the radial displacement stiffness in the direction of the E-shaped magnetic pole 42 unchanged.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A modular five-degree-of-freedom magnetic levitation compressor rotor system, comprising a magnetically levitated rotor spindle and a drive motor arranged at a middle part of the magnetically levitated rotor spindle
wherein a centrifugal impeller and a cooling impeller are respectively mounted at both ends of the magnetically levitated rotor spindle;
wherein an axial magnetic bearing assembly and a radial magnetic bearing assembly are sequentially arranged on the magnetically levitated rotor spindle between the drive motor and the centrifugal impeller, as well as on the magnetically levitated rotor spindle between the drive motor and the cooling impeller;
and wherein the axial magnetic bearing assembly is a thrustless plate structure with a direct magnetic field coupling, and the radial magnetic bearing assembly adopts a modular structure with segmented magnetic poles.

2. The modular five-degree-of-freedom magnetic levitation compressor rotor system according to claim 1, wherein the axial magnetic bearing assembly comprises an axial rotor assembly sleeved outside the magnetically levitated rotor spindle and an axial stator assembly sleeved outside the axial rotor assembly, with an air gap formed between the axial rotor assembly and the axial stator assembly;
wherein the axial stator assembly comprises an axial stator core and an axial coil winding, wherein the axial coil winding is wound between two axial stator magnetic poles on the axial stator core;
wherein the axial rotor assembly comprises an axial rotor core and an axial rotor magnetic pole integrally formed with a surface of the axial rotor core; and
wherein the axial stator poles partially overlap with the axial rotor magnetic poles in an axial direction, with an overlapping width being ⅕ of a width of either the axial rotor magnetic poles or the axial stator magnetic poles, and the overlapping directions of the two axial magnetic bearing assemblies positioned on both sides of the drive motor are opposite.

3. The modular five-degree-of-freedom magnetic levitation compressor rotor system according to claim 2, wherein the radial magnetic bearing assembly comprises cages at two ends, and wherein a modular radial magnetic pole assembly, a radial coil winding and a radial rotor iron core lamination arranged from outside to inside in a mounting cavity enclosed by the cages at the two ends;
wherein the modular radial magnetic pole assembly comprises a plurality of E-shaped magnetic poles uniformly arranged in a circumferential array on an inner wall of one of the cages, middle pole columns are arranged at a middle position of an inner arc side of each E-shaped magnetic poles, side pole columns are axially symmetrically arranged on both sides of the middle pole column, a width of the middle pole column is twice a width of the side pole column, and radial coil windings are wound on both the middle pole column and side pole column;
wherein a number of turns of the radial coil winding wound on the middle pole column is twice a number of turns of the radial coil winding wound on the side pole column; and
wherein the radial coil windings form SNS magnetic poles when energized, thereby forming an electromagnetic circuit from the middle pole column through the radial rotor iron core lamination and side pole column, and back to the middle pole column.

4. The modular five-degree-of-freedom magnetic levitation compressor rotor system according to claim 3, wherein two magnetic pole grooves are provided on an outer arc side of one E-shaped magnetic pole, with the two magnetic pole grooves respectively positioned between the two side pole columns and the middle pole column, and a permanent magnet is arranged in the magnetic pole groove, and wherein a N pole of the permanent magnet is toward the middle pole column to form a permanent magnet magnetic circuit consisting of the N pole of the permanent magnet, the middle pole column, the radial rotor core lamination, the side pole column, and an S pole of the permanent magnet.

5. The modular five-degree-of-freedom magnetic levitation compressor rotor system according to claim 4, wherein the radial coil windings on the side pole column of the same E-shaped magnetic pole are connected in series and then connected together with the radial coil windings wound on the middle pole column to a 2-in-4-out terminal block, and wherein the 2-in-4-out terminal block is connected to a power amplifier, enabling the three radial coil windings on the same E-shaped magnetic pole to share one power amplifier.

6. The modular five-degree-of-freedom magnetic levitation compressor rotor system according to claim 5, wherein both the side pole column and the middle pole column are wound with fault detection coils, and the fault detection coils are electrically connected to an operational amplifier;
wherein, to achieve a magnetic field generated under the action of electromagnetic induction when the current passes through the radial coil winding under normal conditions, when the radial coil winding changes, and the generated magnetic flux then changes, according to Faraday's Law of Electromagnetic Induction and Oersted's Law, the magnetic flux passing through the fault detection coil changes accordingly and an electromotive force is induced, thereby forming a voltage difference Vₒᵤₜ at both ends of the radial coil winding, wherein a voltage difference signal is processed by the operational amplifier and then output to the operational amplifier, and wherein the voltage difference signal amplified by the operational amplifier is used to determine that the radial coil winding is normal;
wherein, when a fault occurs in the radial coil winding, a change in the current flowing to the radial coil winding will not cause a change in the voltage difference signal amplified by the operational amplifier, thereby determining that the fault has occurred in the radial coil winding.

7. The modular five-degree-of-freedom magnetic levitation compressor rotor system according to claim 6, wherein an inductive displacement sensor is further arranged on the magnetically levitated rotor spindle between the radial magnetic bearing assembly and the centrifugal impeller or the cooling impeller, the displacement sensor is electrically connected to the coil windings of the axial magnetic bearing assembly and the radial magnetic bearing assembly through a controller, so as to detect axial and radial displacement signals of the magnetically levitated rotor spindle and control the current supplied to the radial coil winding based on the inductive displacement sensor, thereby ensuring balance and stability of the magnetically levitated rotor spindle;
wherein a protective bearing is arranged between the inductive displacement sensor and the centrifugal impeller or the cooling impeller; and
wherein both the centrifugal impeller and the cooling impeller are provided with splitter blades, and a diameter and a height of the centrifugal impeller are respectively greater than a diameter and a height of the cooling impeller.

8. The modular five-degree-of-freedom magnetic levitation compressor rotor system according to claim 7, wherein the inductive displacement sensors at opposite ends are a radial displacement sensor at one end and an axial-radial integrated displacement sensor at the other end;
wherein the inductive displacement sensor comprises a sensor measuring ring sleeved on the magnetically levitated rotor spindle and a sensor stator core sleeved outside the sensor measuring ring, with the air gap formed between the sensor stator core and the sensor measuring ring, an even number of sensor magnetic poles are uniformly arranged on an inner side of the sensor stator core, wherein each sensor magnetic pole is wound with the sensor coil winding, the opposing sensor coil windings are connected in series with opposite winding directions, and wherein one of two adjacent sensor coil windings is energized while the other is de-energized;
wherein the inductive axial-radial integrated displacement sensor consists of three inductive radial displacement sensor stator cores, with the middle sensor stator core forming a 45° angle with the magnetic poles of the adjacent sensor stator cores on both sides, and the magnetic poles of the sensor stator cores on both sides facing a seam between the sleeve and the sensor measuring ring.

9. The modular five-degree-of-freedom magnetic levitation compressor rotor system according to claim 8, wherein the axial stator core, axial rotor core, radial rotor core lamination, E-shaped magnetic pole and sensor stator core are all made of silicon steel; the permanent magnet is made of rare-earth permanent magnet material; and the sensor measuring ring is made of permalloy.

10. A control method for the modular five-degree-of-freedom magnetic levitation compressor rotor system according to claim 9, wherein the method comprises an axial displacement control and a radial displacement control;
wherein the steps of the axial displacement control are as follows: supplying currents with opposite directions and equal magnitudes to the axial coil windings of the two axial magnetic bearing assemblies position on both sides of the drive motor, so that a resultant axial force on the magnetically levitated rotor spindle is zero and the levitation balance is maintained;
when the magnetically levitated rotor spindle drives the axial rotor assembly to undergo the axial displacement, causing a degree of overlap between the axial stator magnetic poles and the axial rotor magnetic poles to change, at this point, reducing the current supplied to the axial coil winding on the side where the degree of overlap increases, and increasing the current supplied to the axial coil winding on the side where the degree of overlap decreases, thereby generating a reverse axial electromagnetic force until the magnetically levitated rotor spindle restores balance;
wherein the radial displacement control comprises a speed-based variable bias current control strategy and a redundant control strategy under fault conditions, wherein the speed-based variable bias current control strategy is as follows: when the speed of the magnetically levitated rotor spindle is zero or lower than a preset first threshold, the magnetically levitated rotor spindle is levitated by utilizing the permanent magnetic force provided by the permanent magnet; when the magnetically levitated rotor spindle rotates at a second threshold, a first bias current is supplied to the radial coil winding to generate the electromagnetic magnetic circuit, and the electromagnetic magnetic circuit is superimposed with the permanent magnetic circuit generated by the permanent magnet to enhance radial stiffness, thereby levitating the magnetically levitated rotor spindle; when the magnetically levitated rotor spindle rotates at a third threshold, a second bias current is supplied to the radial coil winding to increase the radial stiffness, thereby levitating the magnetically levitated rotor spindle; wherein the third threshold, the second threshold, and the first threshold decrease sequentially, and the second bias current is greater than the first bias current; and
wherein the redundant control strategy is as follows: when a fault occurs in the radial coil winding on the side pole column, the current of the radial coil winding on the middle pole column is increased to compensate the electromagnetic magnetic flux, thereby maintaining the radial displacement stiffness in the direction of the E-shaped magnetic pole unchanged; and, when a fault occurs in the radial coil winding on the middle pole column, the current of the radial coil windings on the two side pole columns are increased to compensate the electromagnetic magnetic flux, thereby maintaining the radial displacement stiffness in the direction of the E-shaped magnetic pole unchanged.
